(19) United States
(12) Patent Application Publication
(10) Pub. No.: US 2024/0051007 A1
(43) Pub. Date: Feb. 15, 2024

(54) FORMING SYSTEM, ELECTRIC HEATING SYSTEM, ELECTRODE, FORMING DEVICE, AND SUPPORT DEVICE

(71) Applicant: SUMITOMO HEAVY INDUSTRIES, LTD., Tokyo (JP)

(72) Inventors: Noboru ITAGAKI, Niihama-shi (JP); Kei YAMAUCHI, Niihama-shi (JP); Kiyomasa KOUKAMI, Niihama-shi (JP)

(21) Appl. No.: 18/493,705

(22) Filed: Oct. 24, 2023

Related U.S. Application Data
(63) Continuation of application No. PCT/JP2022/023181, filed on Jun. 8, 2022.

(30) Foreign Application Priority Data
Jun. 9, 2021 (JP) 2021-096621

(51) Int. Cl. B21D 26/033; B21D 37/16

(52) U.S. Cl. CPC B21D 26/033; B21D 37/16; H05B 3/40

(57) ABSTRACT

A forming system includes a forming device that forms a heated metal material, and includes a holding mechanism that holds the metal material, and an adjustment mechanism that adjusts a posture of at least one of the holding mechanism or the metal material in accordance with a fact that the heated metal material is deformed.

### CROSS-REFERENCE TO RELATED APPLICATIONS

This is a bypass continuation of International PCT Application No. PCT/JP2022/023181, filed on Jun. 8, 2022, which claims priority to Japanese Patent Application No. 2021-096621, filed on Jun. 9, 2021, which are incorporated by reference herein in their entirety.

### BACKGROUND

### Technical Field

A certain embodiment of the present disclosure relates to a forming system, an electric heating system, an electrode, a forming device, and a support device.

### Description of Related Art

In related art, a system described in the related art has been known as an electric heating system in which a metal pipe material is held by an electrode and is energized and heated. In the electric heating system described in the related art, the metal pipe material is held by the electrode, and is energized and heated by causing a current to flow from the electrode to the metal pipe material. The heated metal pipe material is formed by a forming tool.

### SUMMARY

According to an aspect of the present invention, there is provided is a forming system including a forming device that forms a heated metal material, including: a holding mechanism that holds the metal material; and an adjustment mechanism that adjusts a posture of at least one of the holding mechanism or the metal material in accordance with a fact that the heated metal material is deformed.

According to another aspect of the present invention, there is provided is an electric heating system including: an electrode that holds a bent metal material and energizes and heats the metal material; and an adjustment mechanism that rotates the electrode around a predetermined reference position to adjust a posture.

According to still another aspect of the present invention, there is provided is an electric heating system including: an electrode that holds a bent metal material, and energizes and heats the metal material; and an adjustment mechanism that adjusts a posture of the electrode in accordance with a fact that the metal material is deformed in a case where the metal material is heated by the electrode.

An electrode according to the present disclosure holds a bent metal material and energizes and heats the metal material, and the electrode is adjusted in a posture by rotating around a predetermined reference position.

A forming device according to the present disclosure performs expansion forming of a heated metal pipe material, and includes a holding mechanism that holds the metal pipe material, and an adjustment mechanism that adjusts a relative posture of the holding mechanism with respect to the metal pipe material in accordance with positional deviation of the metal pipe material during the holding.

A support device according to the present disclosure includes: a holding mechanism that holds a heated metal pipe material to perform expansion forming of the metal pipe material; and an adjustment mechanism that adjusts a relative posture of the holding mechanism with respect to the metal pipe material in accordance with positional deviation of the metal pipe material during the holding.

### BRIEF DESCRIPTION OF THE DRAWINGS

FIG. 1 is a schematic view illustrating a configuration of a forming device including an electric heating system according to an embodiment of the present disclosure.

FIG. 2 is a plan view schematically illustrating a heating and expanding mechanism.

FIG. 3 is a front view of a heating and expanding unit as viewed from a metal pipe side in a longitudinal direction.

FIG. 4 is a side view of the heating and expanding unit as viewed in a width direction.

FIG. 5 is a cross-sectional view taken along line V-V illustrated in FIG. 3.

FIGS. 6A and 6B are schematic views illustrating one heating and expanding unit of the electric heating system.

FIGS. 7A and 7B are schematic views illustrating one heating and expanding unit of the electric heating system.

FIGS. 8A and 8B are schematic views illustrating one heating and expanding unit of the electric heating system.

FIGS. 9A and 9B are schematic views illustrating one heating and expanding unit of the electric heating system.

FIGS. 10A and 10B schematic views illustrating one heating and expanding unit of the electric heating system.

FIGS. 11A and 11B are schematic views illustrating one heating and expanding unit of the electric heating system.

FIGS. 12A and 12B are schematic views illustrating one heating and expanding unit of the electric heating system.

FIGS. 13A and 13B are schematic views illustrating one heating and expanding unit of the electric heating system.

FIGS. 14A and 14B are schematic views illustrating a forming device and a support device according to a modification example.

FIGS. 15A and 15B are schematic views illustrating the forming device and the support device according to the modification example.

FIGS. 16A and 16B are schematic views illustrating the forming device and the support device according to the modification example.

FIGS. 17A and 17B are schematic views illustrating the forming device and the support device according to the modification example.

FIGS. 18A and 18B are schematic views illustrating the forming device and the support device according to the modification example.

FIGS. 19A and 19B are schematic views illustrating the forming device and the support device according to the modification example.

### DETAILED DESCRIPTION

Here, a material that has been bent in advance may be adopted (pre-formed) as the metal material. In this case, the electrode needs to hold the metal material in a bent state. However, in a case where the metal material in the bent state is heated, an angle of the metal material with respect to the electrode deviates due to thermal elongation. Such deviation between the electrode and the metal material may influence the quality of forming or the like. From the above, it is necessary to cope with the influence of heat due to the heating of the metal material.

It is desirable to provide a forming system, an electric heating system, an electrode, a forming device, and a support device capable of coping with the influence of heat due to heating of a metal material.

In accordance with the forming system according to the present disclosure, the adjustment mechanism adjusts the posture of at least one of the holding mechanism or the metal material in accordance with the fact that the heated metal material is deformed.

Accordingly, even in a case where the position of the metal material deviates from the holding mechanism, the holding mechanism can hold the metal material in an appropriate posture.

The metal material may be heated outside the forming device.

The adjustment mechanism may adjust the posture of at least one of the holding mechanism or the metal material in accordance with a fact that the metal material is heated outside the forming device and is deformed during transportation to the forming device. In this case, it is possible to perform forming corresponding to the deformation of the metal material caused during the transportation to the forming device. In this case, it is possible to perform forming corresponding to the deformation of the metal material caused during the transportation to the forming device.

The metal material may be heated inside the forming device.

The adjustment mechanism may adjust the posture of at least one of the holding mechanism or the metal material in accordance with a fact that the metal material is heated inside the forming device and is deformed during heating. In this case, it is possible to perform forming corresponding to the deformation of the metal material caused during the heating inside the forming device. In this case, it is possible to perform forming corresponding to the deformation of the metal material caused during the heating inside the forming device.

The electric heating system includes the adjustment mechanism that rotates the electrode around the predetermined reference position to adjust the posture. In a case where the electrode heats the metal material, thermal elongation is generated in the metal material. At this time, in a case where an angle of the metal material deviates from the electrode, the adjustment mechanism can rotate the electrode around the predetermined reference position according to the deviation to adjust the posture. Accordingly, the adjustment mechanism can reduce the deviation of the angle of the electrode from the metal material. From the above, it is possible to absorb the thermal elongation in a case where the bent metal material is heated.

The electric heating system includes the adjustment mechanism that adjusts the posture of the electrode in accordance with the fact that the metal material is deformed in a case where the metal material is heated by the electrode. In a case where the electrode heats the metal material, thermal elongation is generated in the metal material. At this time, in a case where the position of the metal material deviates from the electrode, the adjustment mechanism can adjust the posture of the electrode in accordance with the fact that the metal material is deformed in accordance with the deviation. Accordingly, the adjustment mechanism can reduce the deviation of the position of the electrode from the metal material. From the above, it is possible to absorb the thermal elongation in a case where the bent metal material is heated.

The adjustment mechanism includes at least a pair of cylinders provided for the electrode. In this case, the adjustment mechanism can accurately adjust the posture of the electrodes by using the pair of cylinders.

The electrode moves according to expansion in a longitudinal direction of the metal material and is adjusted in the posture by the adjustment mechanism while heating the metal material after holding the metal material, and releases the holding and holds the metal material again after the movement and the adjustment in the posture. In this case, in a case where the reaction force due to the thermal expansion is generated between the electrode and the metal material by releasing the holding of the electrode after the movement and the adjustment in the posture, the reaction force can be released. Then, in a state in which the reaction force is released, the electrode can hold the metal material again in an appropriate posture corresponding to the thermal elongation.

The electric heating system further includes a fluid supply unit that supplies a fluid to a metal pipe material as the metal material, and after the electrode holds the metal pipe material again, the fluid supply unit supplies the fluid to the metal pipe material. Even in a case where a gap is formed between a die and the metal pipe material due to the influence of the reaction force due to the thermal expansion, the electrode performs the holding again after releasing the holding, and thus, the gap between the die and the metal pipe material can be reduced. The fluid supply unit can form a high-quality molding product by supplying the fluid to the metal pipe material in the state.

In accordance with the electrodes according to the present disclosure, it is possible to obtain operations and effects having the same meaning as that of the above-described electric heating system.

In accordance with the forming device according to the present disclosure, the adjustment mechanism adjusts the relative posture of the holding mechanism with respect to the metal pipe material in accordance with the positional deviation of the metal pipe material during holding. Accordingly, even in a case where the position of the metal pipe material deviates from the holding mechanism, the holding mechanism can hold the metal pipe material in an appropriate posture.

The adjustment mechanism may adjust the posture of the holding mechanism with respect to the metal pipe material. In this case, since the holding mechanism adjusts the posture in accordance with the positional deviation of the metal pipe material, it is possible to suppress the crushing of the metal pipe material or the like.

The adjustment mechanism may deform the metal pipe material in accordance with the holding aspect of the holding mechanism. In this case, the metal pipe material is deformed so as to have a shape that matches the holding mechanism, and thus, the holding mechanism can hold the metal pipe material in an appropriate posture.

The adjustment mechanism may adjust the posture in accordance with the fact that the metal pipe material is deformed in a case where the metal pipe material is heated in a preliminary stage of being held by the holding mechanism and moves to the holding mechanism. In this case, even though the heated metal pipe material is deformed during moving, the holding mechanism can hold the metal pipe material in an appropriate posture.

In accordance with the present disclosure, it is possible to provide the forming system, the electric heating system, the electrode, the forming device, and the support device that can cope with the influence of the heat due to the heating of the metal material.

Hereinafter, a preferred embodiment of the present disclosure will be described with reference to the drawings. In addition, in the respective drawings, the same portions or corresponding portions are designated by the same reference signs, and duplicated descriptions will not be repeated.

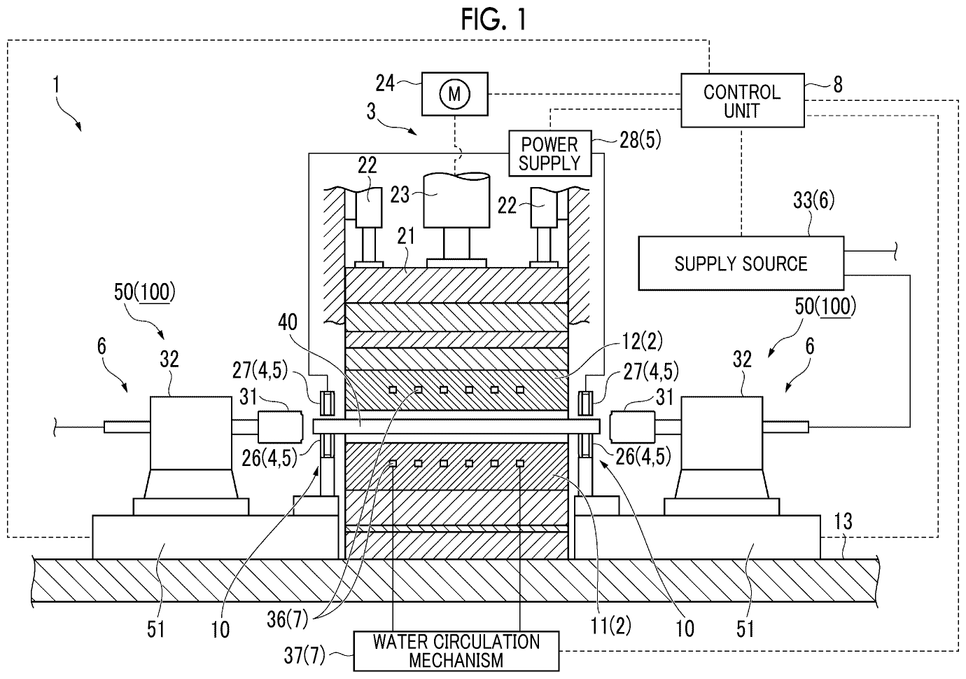

FIG. 1 is a schematic view illustrating a configuration of a forming device 1 (forming system) including an electric heating system 100 according to the embodiment of the present disclosure. As illustrated in FIG. 1, the forming device 1 is a device that forms a metal pipe having a hollow shape by blow forming. In the present embodiment, the forming device 1 is installed on a horizontal plane. The forming device 1 includes a forming tool 2 (forming die), a drive mechanism 3, holding units 4, heating units 5, fluid supply units 6, cooling units 7, and a control unit 8. In addition, in the present specification, the metal pipe refers to a hollow article after the forming in the forming device 1 is completed, and a metal pipe material 40 (metal material) refers to a hollow article before the forming in the forming device 1 is completed. The metal pipe material 40 is a steel-type pipe material that can be hardened. Additionally, in a horizontal direction, a direction in which the forming tool 2 extends along a direction in which the metal pipe material 40 extends during forming may be referred to as an “extending direction”, and a direction perpendicular to the extending direction may be referred to as a “lateral direction”.

The forming tool 2 is a die that forms the metal pipe material 40 into a metal pipe, and includes a lower die 11 and an upper die 12 that face each other in a vertical direction. The lower die 11 and the upper die 12 are made of steel blocks. The lower die 11 is fixed to a base stage 13 via a die holder or the like. The upper die 12 is fixed to a slide of the drive mechanism 3 via a die holder or the like.

The drive mechanism 3 is a mechanism that moves at least one of the lower die 11 and the upper die 12. In FIG. 1, the drive mechanism 3 has a configuration in which only the upper die 12 is moved. The drive mechanism 3 includes a slide 21 that moves the upper die 12 such that the lower die 11 and the upper die 12 are joined together, and a pull-back cylinder 22 serving as an actuator that generates a force for pulling the slide 21 upward, a main cylinder 23 serving as a drive source that downward-pressurizes the slide 21, and a drive source 24 that applies a driving force to the main cylinder 23.

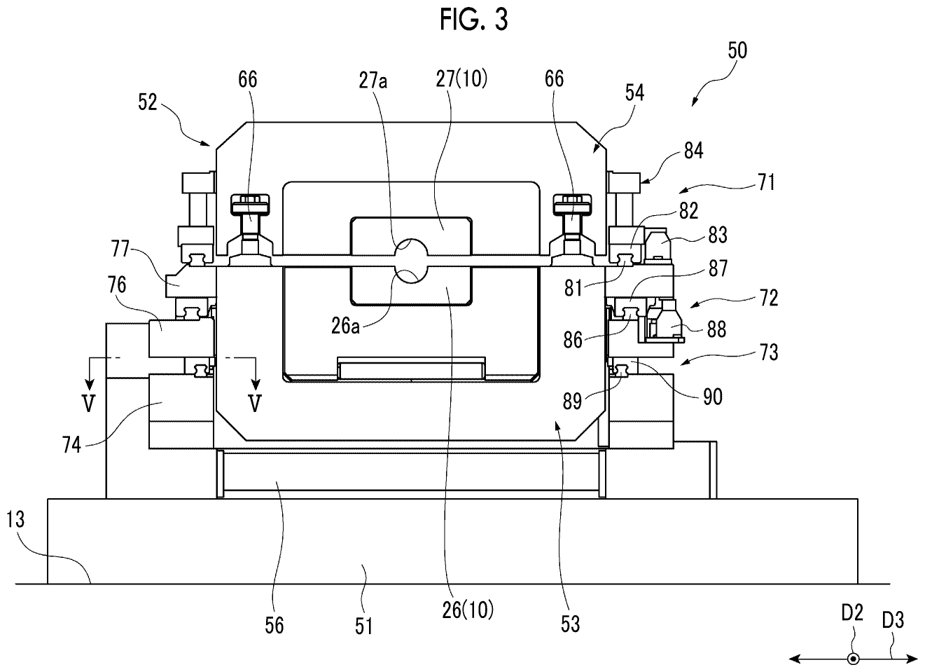

The holding unit 4 is a mechanism that holds the metal pipe material 40 disposed between the lower die 11 and the upper die 12. The holding unit 4 includes electrodes 10 (holding mechanism) on both sides in the extending direction. Specifically, the holding unit 4 includes a lower electrode 26 and an upper electrode 27 that hold the metal pipe material 40 on one end side in the extending direction of the forming tool 2, and a lower electrode 26 and an upper electrode 27 that hold the metal pipe material 40 on the other end side in the extending direction of the forming tool 2. The lower electrodes 26 and the upper electrodes 27 on both sides in the extending direction hold the metal pipe material 40 by sandwiching vicinities of end portions of the metal pipe material 40 from the vertical direction. In addition, groove portions 26a and 27a having a shape corresponding to an outer peripheral surface of the metal pipe material 40 are formed on an upper surface of the lower electrode 26 and a lower surface of the upper electrode 27 (see FIG. 3). Drive mechanisms (not illustrated) are provided in the lower electrode 26 and the upper electrode 27, and are movable independently in the vertical direction.

The heating unit 5 heats the metal pipe material 40. The heating unit 5 is a mechanism that heats the metal pipe material 40 by energizing the metal pipe material 40. The heating unit 5 heats the metal pipe material 40 in a state in which the metal pipe material 40 is spaced apart from the lower die 11 and the upper die 12 between the lower die 11 and the upper die 12. The heating unit 5 includes the electrodes 10 on both sides in the extending direction, that is, the lower electrodes 26 and the upper electrodes 27 on both sides in the extending direction and a power supply 28 that causes current to flow to the metal pipe material via the electrodes 26 and 27.

The fluid supply unit 6 is a mechanism that supplies a high-pressure fluid into the metal pipe material 40 held between the lower die 11 and the upper die 12. The fluid supply unit 6 supplies the high-pressure fluid into the metal pipe material 40 that has been brought into a high-temperature state by being heated by the heating unit 5 and expands the metal pipe material 40. The fluid supply units 6 are provided on both end sides of the forming tool 2 in the extending direction. The fluid supply unit 6 includes a nozzle 31 that supplies a fluid from opening portions of end portions of the metal pipe material 40 to an inside of the metal pipe material 40, a drive mechanism 32 that moves the nozzle 31 to advance and retreat with respect to the opening portion of the metal pipe material 40, and a supply source 33 that supplies the high-pressure fluid into the metal pipe material 40 via the nozzle 31. The drive mechanism 32 causes the nozzle 31 to be brought into close contact with the end portion of the metal pipe material 40 in a state in which sealing performance is secured during fluid supply and exhaust, and causes the nozzle 31 to be spaced apart from the end portion of the metal pipe material 40 at other times. In addition, the fluid supply unit 6 may supply a gas such as high-pressure air or an inert gas as the fluid. Additionally, the fluid supply unit 6 may include the heating unit 5 together with the holding unit 4 having a mechanism that moves the metal pipe material 40 in the vertical direction as the same device.

Heating and expanding units 50 are constructed by providing the electrodes 10 and the fluid supply units 6 on a base portion 51 and unitizing the electrodes and the fluid supply units. The electric heating system 100 is constructed by combining the heating and expanding units 50 on both sides in the extending direction. In addition, a more detailed description of the heating and expanding unit 50 will be described later.

The cooling unit 7 is a mechanism that cools the forming tool 2. By cooling the forming tool 2, the cooling units 7 can rapidly cool the metal pipe material 40 in a case where the expanded metal pipe material 40 has come into contact with a forming surface of the forming tool 2. The cooling unit 7 includes a flow path 36 formed inside the lower die 11 and the upper die 12, and a water circulation mechanism 37 that supplies cooling water to the flow path 36 and circulates the cooling water.

The control unit 8 is a device that controls the entire forming device 1. The control unit 8 controls the drive mechanism 3, the holding units 4, the heating units 5, the fluid supply units 6, and the cooling units 7. The control unit 8 repeatedly performs an operation of forming the metal pipe material 40 with the forming tool 2.

Specifically, the control unit 8 controls, for example, a transport timing from a transport device such as a robot arm to dispose the metal pipe material 40 between the lower die 11 and the upper die 12 in an open state. Alternatively, the control unit 8 may wait for a worker to manually dispose the metal pipe material 40 between the lower die 11 and the upper die 12. Additionally, the control unit 8 controls an actuator of the holding unit 4 and the like such that the metal pipe material 40 is supported by the lower electrodes 26 on both sides in the extending direction and then the upper electrodes 27 are lowered to sandwich the metal pipe material 40. Additionally, the control unit 8 controls the heating units 5 to energize and heat the metal pipe material 40. Accordingly, a current in an axial direction flows through the metal pipe material 40, and an electric resistance of the metal pipe material 40 itself causes the metal pipe material 40 itself to generate heat due to Joule heat.

The control unit 8 controls the drive mechanism 3 to lower the upper die 12 and bring the upper die close to the lower die 11 to close the forming tool 2. On the other hand, the control unit 8 controls the fluid supply units 6 to seal the opening portions of both ends of the metal pipe material 40 with the nozzle 31 and supply the fluids. Accordingly, the metal pipe material 40 softened by heating expands and comes into contact with the forming surface of the forming tool 2. Then, the metal pipe material 40 is formed so as to follow a shape of the forming surface of the forming tool 2. In a case where the metal pipe material 40 comes into contact with the forming surface, quenching of the metal pipe material 40 is performed by being rapidly cooled with the forming tool 2 cooled by the cooling units 7.

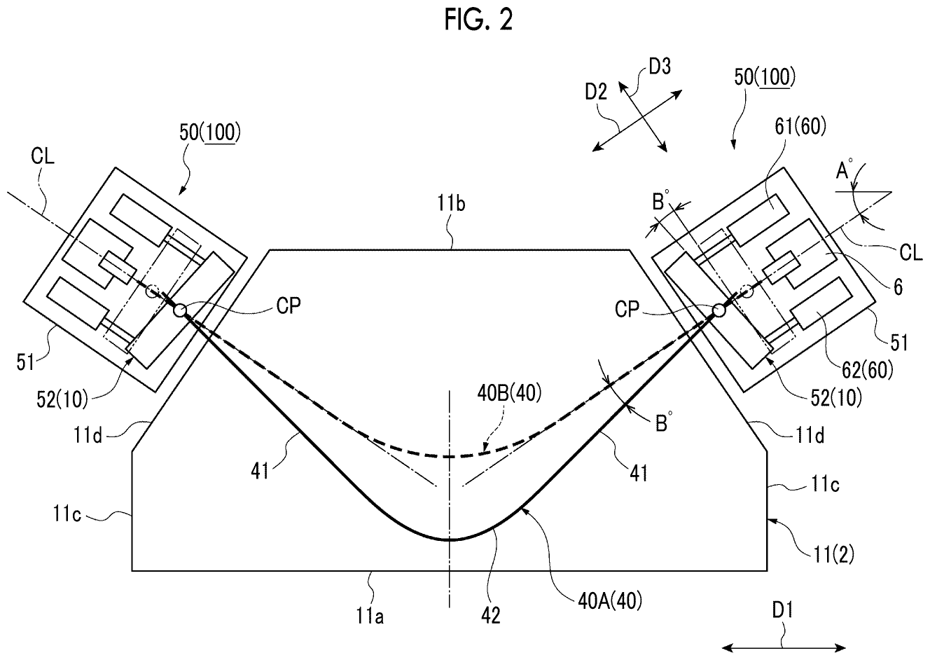

Here, as illustrated in FIG. 2, the forming device 1 forms the metal pipe material 40 in a pre-bent state. The metal pipe material 40 has a bent shape in a curved state in the horizontal plane. Specifically, the metal pipe material 40 includes straight portions 41 extending linearly at both end portions in a longitudinal direction and a bent portion 42 bent in an arc shape with a predetermined curvature at a center position in the longitudinal direction. The electrodes 10 on both sides in the longitudinal direction hold the metal pipe material 40 in a state of being inclined in the horizontal plane in accordance with an angle of each straight portion 41. Assuming that the extending direction of the forming device 1 is “D1”, the straight portions 41 are inclined with respect to the extending direction D1. Additionally, the bent portion 42 of the metal pipe material 40 is formed to be convex to one side in the lateral direction perpendicular to the extending direction D1. In addition, in some cases, a side on which the bent portion 42 protrudes is referred to as a “front” side, and a side opposite to the bent portion is referred to as a “rear” side. The lower die 11 has a front surface 11a on the front side and a rear surface 11b on the rear side. The front surface 11a and the rear surface 11b extend parallel to the extending direction D1. The die 11 has end faces 11c perpendicular to the extending direction D1 on both sides of the extending direction D1. Additionally, inclined surfaces 11d are provided at portions of the metal pipe material 40 that are held by the electrodes 10. The inclined surfaces 11d extend so as to be inclined with respect to the extending direction D1. The inclined surfaces 11d are formed between the rear surface 11b and the end faces 11c.

Here, in FIG. 2, a metal pipe material 40A illustrated by a solid line indicates the metal pipe material 40 in a state before heating. On the other hand, a metal pipe material 40B illustrated by a broken line indicates the metal pipe material 40 in a heated state. As can be seen from the states before and after heating, the metal pipe material 40 expands such that the bent shape is stretched by heating. Accordingly, an angular difference of an angle of “B °” is formed between the straight portion 41 of the metal pipe material 40A before heating and the straight portion 41 of the metal pipe material 40B after heating. In addition, here, the “metal pipe material 40B after heating” refers to the metal pipe material 40 in a state in which heating for a predetermined heating time is completed.

Here, a center line CL of the heating and expanding unit 50 is set to coincide with the straight portion 41 (center line of the straight portion 41) of the metal pipe material 40B after heating. The center line CL of the heating and expanding unit 50 coincides with a center line of the fluid supply unit 6 (a center line of the nozzle 31). Accordingly, the fluid supply unit 6 can supply the fluid from the end portion of the straight portion 41 in a state in which the angle with the straight portion 41 of the metal pipe material 40B after heating is matched. In addition, an angle formed by the center line CL with respect to the extending direction D1 is indicated by “A °”. In the following description, a direction in which the straight portion 41 extends and a direction parallel to the center line CL are referred to as a longitudinal direction D2. Additionally, a horizontal direction perpendicular to the longitudinal direction D2 is referred to as a width direction D3.

The heating and expanding unit 50, that is, the electric heating system 100, includes adjustment mechanisms 60 that adjust the postures by rotating (tilting) the electrodes 10 around predetermined reference positions CP. The adjustment mechanism 60 is a mechanism that adjusts the posture of the electrode 10 in accordance with the fact that the metal pipe material 40A is deformed in a case where the metal pipe material 40A is heated by the electrode 10. In a case where the metal pipe material 40A before heating is held, the electrode 10 is disposed so as to be perpendicular to the straight portion 41 of the metal pipe material 40A before heating. On the other hand, in a case where the metal pipe material 40B after heating is held, the electrode 10 is disposed so as to be perpendicular to the straight portion 41 of the metal pipe material 40B after heating (see the electrode 10 indicated by an imaginary line). In this manner, an angular difference of “B °” is formed between the electrode 10 that holds the metal pipe material 40A before heating and the electrode 10 that holds the metal pipe material 40B after heating. Accordingly, the adjustment mechanism 60 rotates the electrode 10 around the reference position CP by “B °”. In addition, the reference position CP is set at the center position of the electrode 10 as viewed in the vertical direction. Additionally, a rotation axis of rotation of the electrode 10 is set at the reference position CP.

The adjustment mechanism 60 includes a pair of cylinders 61 and 62 provided for the electrode 10. The cylinder 61 is provided on one end side in the width direction D3 of an electrode unit 52 including the electrode 10. The cylinder 62 is provided on the other end side in the width direction D3 of the electrode unit 52. Accordingly, the pair of cylinders 61 and 62 are provided on both end sides with the reference position CP of the electrode unit 52 interposed therebetween in the width direction D3. The cylinders 61 and 62 are provided on a side opposite to the forming tool 2 in the longitudinal direction D2. In addition, the cylinder 61 is a cylinder that generates a driving force for rotating the electrode 10. The cylinder 61 rotates the electrode unit 52 by expanding and contracting a rod connected to the electrode unit 52. On the other hand, the cylinder 62 is a cylinder for following the movement of the electrode 10 accompanying thermal elongation of the metal pipe material 40. The cylinder 62 expands and contracts the rod connected to the electrode unit 52 so as to correspond to a rotational operation of the electrode unit 52. The cylinder 62 does not generate a driving force, but supports the electrode unit 52 on the side opposite to the cylinder 61 such that the rotational operation of the electrode unit 52 is stable. For example, in a case where the cylinder 61 extends the rod, one end portion of the electrode unit 52 moves to the forming tool 2 side. Accordingly, the other end portion of the electrode unit 52 moves away from the forming tool 2, and the rod of the cylinder 62 contracts. In this manner, the electrode 10 rotates around the reference position CP. The operation of the cylinder 62 is controlled by the control unit 8.

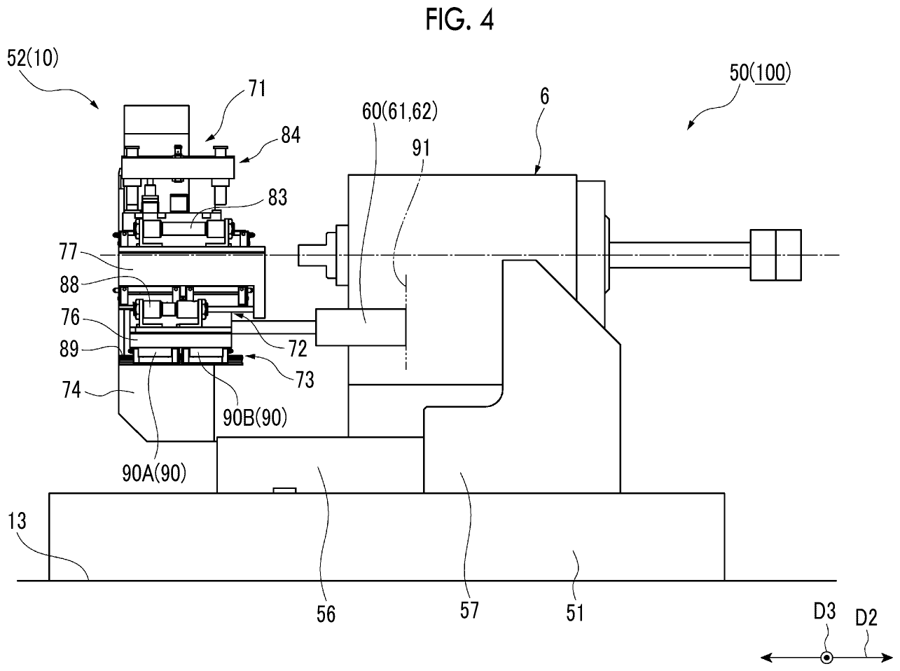

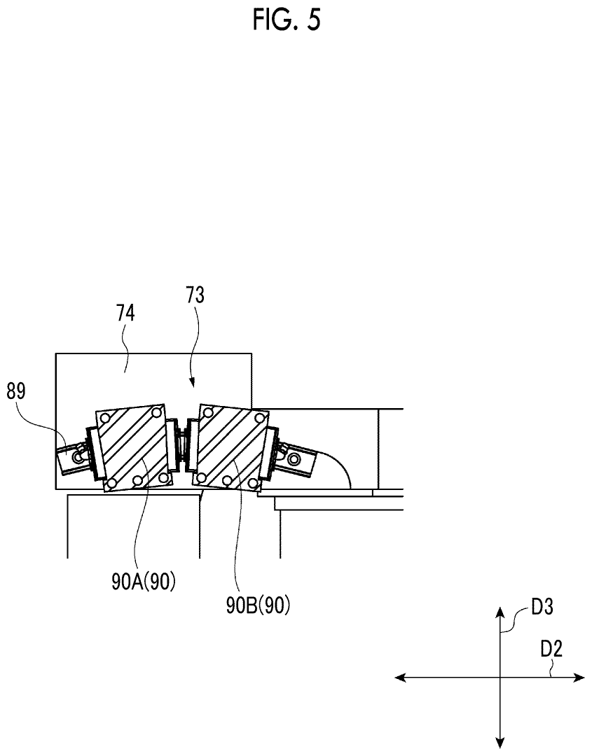

Next, an example of a detailed structure of the heating and expanding unit 50 will be described with reference to FIGS. 3 to 5. FIG. 3 is a front view of the heating and expanding unit 50 as viewed from a metal pipe 20 side in the longitudinal direction D2. FIG. 4 is a side view of the heating and expanding unit 50 as viewed from the width direction D3. FIG. 5 is a cross-sectional view taken along line V-V illustrated in FIG. 3. However, the structure illustrated in FIGS. 3 to 5 is merely an example, and the configurations of various components may be changed as appropriate. In addition, in FIG. 3, there is a case where members having the same meaning are provided on both sides in the width direction D3, but there is a case where a reference sign is given to only one of the members and the other is omitted.

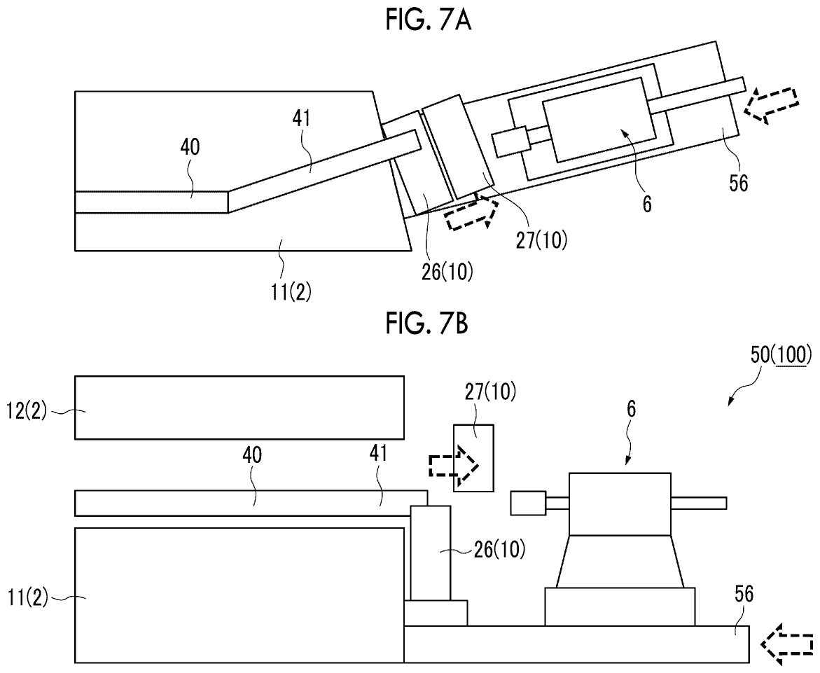

As illustrated in FIG. 4, the heating and expanding unit 50 includes the base portion 51, a moving base portion 56, the electrode unit 52, and the fluid supply unit 6. The base portion 51 is a member that is fixed onto the base stage 13 and supports each component of the heating and expanding unit 50 by disposing each component upward. The moving base portion 56 is a member that is provided on the base portion 51 and slides on the base portion 51 in the longitudinal direction D2. The electrode unit 52 and the fluid supply unit 6 are provided on the moving base portion 56. Accordingly, the moving base portion 56 moves, and thus, the entire electrode unit 52 and fluid supply unit 6 move in the longitudinal direction D2 (see FIGS. 7A and 7B). In addition, a support portion 57 on which a drive unit or the like for sliding the moving base portion 56 is provided is fixed onto the base portion 51.

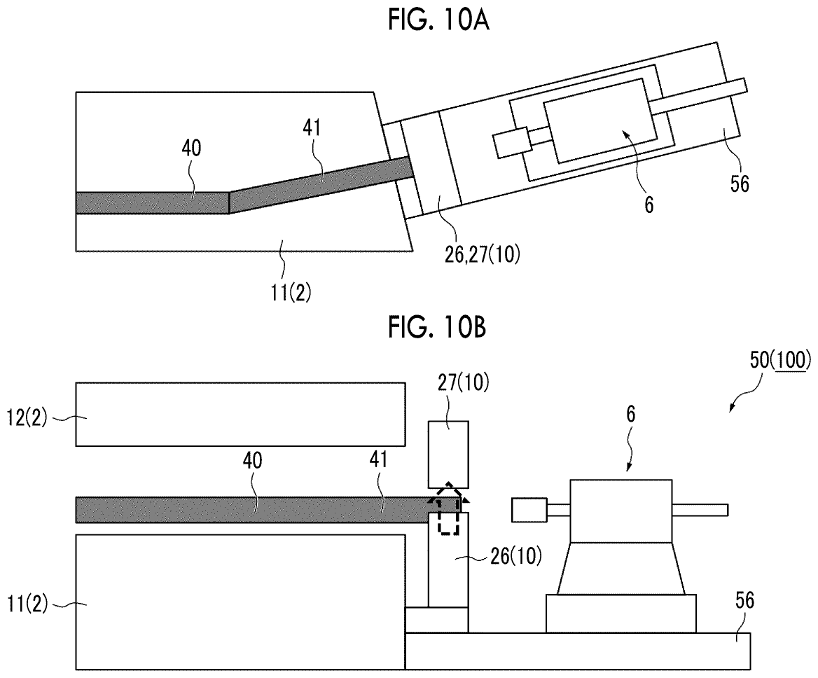

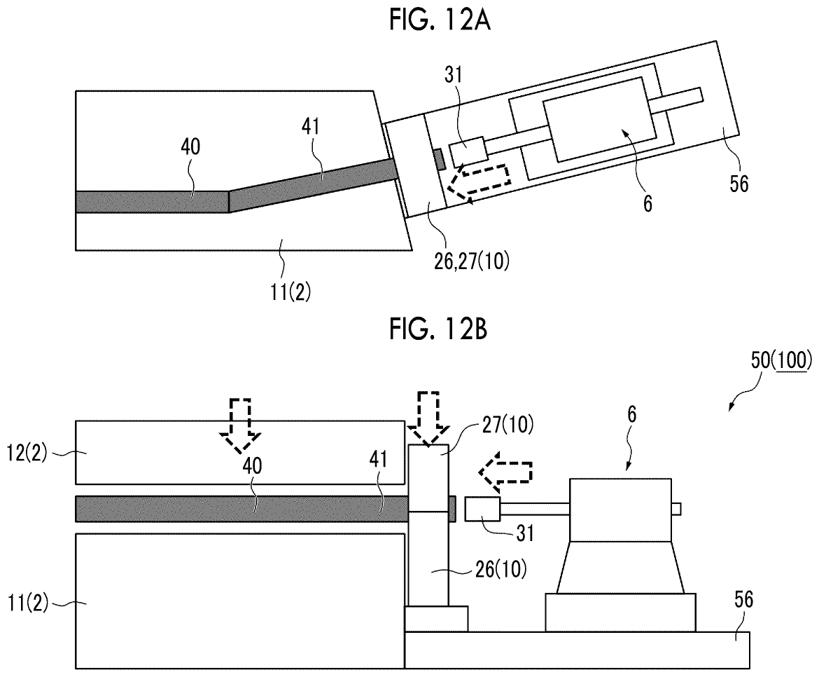

As illustrated in FIG. 3, the electrode unit 52 includes a lower frame 53 that supports the lower electrode 26 and an upper frame 54 that supports the upper electrode 27. An elevation mechanism 66 for moving the upper frame 54 up and down is provided at an upper end of the lower frame 53. The elevation mechanism 66 can release the holding of the metal pipe material 40 by the electrode 10 by lifting the upper electrode 27 with respect to the lower electrode 26 (see FIGS. 10A and 10B). Additionally, the elevation mechanism 66 can hold the metal pipe material 40 by the electrode 10 by lowering the upper electrode 27 with respect to the lower electrode 26 (see FIGS. 12A and 12B).

An upper electrode moving mechanism 71 that moves the upper electrode 27 in the longitudinal direction D2, a lower electrode moving mechanism 72 that moves the lower electrode 26 in the longitudinal direction D2, and a rotational operation guide mechanism 73 that guides a rotational operation of the electrode 10 are provided in the electrode unit 52. Additionally, a support member 74, a support member 76, and a support member 77 are provided on both sides in the width direction D3 of the lower frame 53 in this order from the bottom. The support member 74 is fixed to the moving base portion 56 and is not fixed to the lower frame 53. The support member 76 is provided on an upper side of the support member 74 via the rotational operation guide mechanism 73, and is not fixed to the lower frame 53. The support member 77 is provided on the upper side of the support member 74 via the lower electrode moving mechanism 72, and is fixed to the lower frame 53.

The upper electrode moving mechanism 71 is provided on the support member 77. The upper electrode moving mechanism 71 includes a pair of guide units 81, a pair of slide units 82, an actuator 83, and a pair of connection units 84. The guide unit 81 is a member provided on an upper surface of each support member 77 so as to extend in the longitudinal direction D2. The slide unit 82 is a member that slides in the longitudinal direction D2 along each guide unit 81. The actuator 83 is a device that is provided on one of the support members 77 and applies a driving force in the longitudinal direction D2 to the slide unit 82. The connection unit 84 is a mechanism for connecting the slide unit 82 and the upper frame 54. The connection unit 84 allows the upper frame 54 to move up and down with respect to the slide unit 82, and restricts the movement of the upper frame with respect to the slide unit 82 in the longitudinal direction D2. Accordingly, the slide unit 82 moves in the longitudinal direction D2, and thus, the upper frame 54 also moves via the connection unit 84. Accordingly, the upper electrode 27 moves in the longitudinal direction (see FIGS. 7A and 7B, 8A and 8B, and 13A and 13B). The actuator 83 is controlled by the control unit 8.

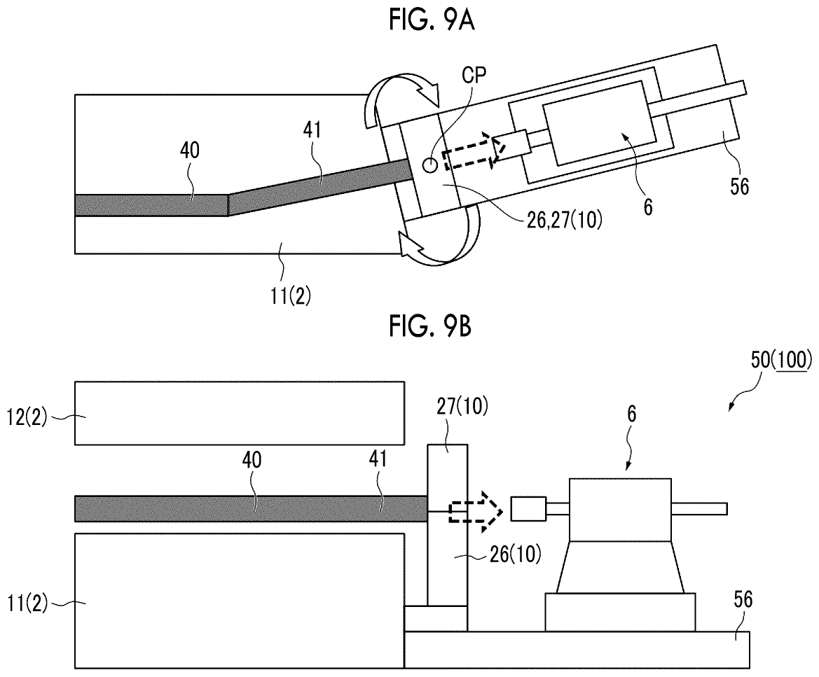

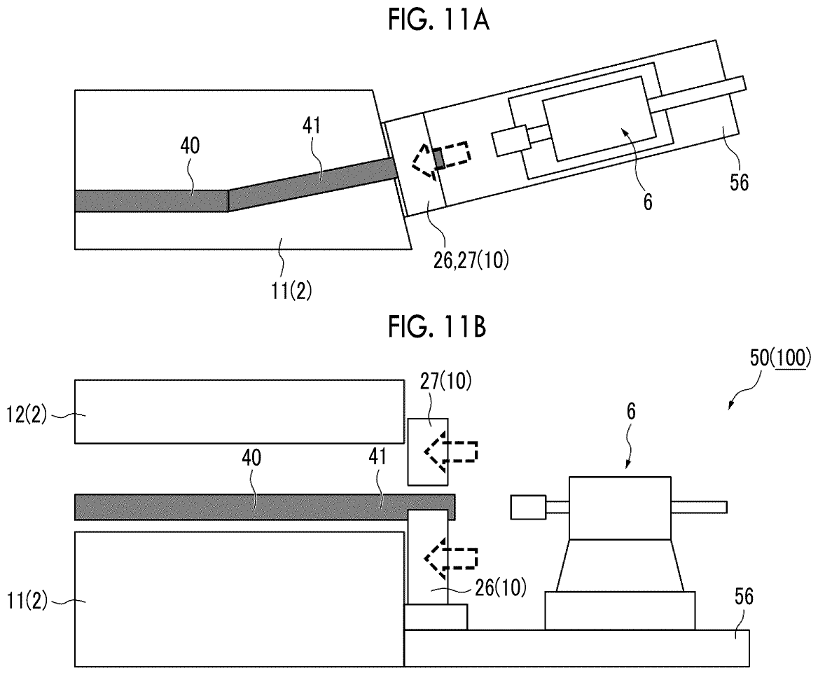

The lower electrode moving mechanism 72 is provided between the support member 76 and the support member 77. The lower electrode moving mechanism 72 includes a pair of guide units 86, a pair of slide units 87, and an actuator 88. The guide unit 86 is a member provided on an upper surface of each support member 76 so as to extend in the longitudinal direction D2. The slide unit 87 is a member that slides in the longitudinal direction D2 along each guide unit 86. An upper end of the slide unit 87 is fixed to the support member 77. The actuator 88 is a device that is provided on one of the support members 76 and applies a driving force in the longitudinal direction D2 to the slide unit 87. Accordingly, the slide unit 87 moves in the longitudinal direction D2, and thus, the lower frame 53 moves via the support member 77. Accordingly, the lower electrode 26 moves in the longitudinal direction (see FIGS. 9A and 9B and 11A and 11B). In addition, as the lower frame 53 moves, the upper frame 54 also moves in the longitudinal direction D2. The actuator 88 is controlled by the control unit 8.

The rotational operation guide mechanism 73 is provided between the support member 74 and the support member 76. The rotational operation guide mechanism 73 includes a pair of guide units 89 and a pair of slide units 90. The guide unit 89 is a member provided on an upper surface of each support member 74. The slide unit 90 is a member that slides along each guide unit 89. An upper end of the slide unit 90 is fixed to the support member 76. As illustrated in FIG. 5, the guide unit 89 has an arc shape extending along the longitudinal direction D2 on the upper surface of the support member 74. The guide unit 89 is curved so as to protrude outward in the width direction D3. The slide unit 90 has a pair of guide members 90A and 90B slidably provided with respect to the guide unit 89.

As illustrated in FIG. 4, one end sides of the cylinders 61 and 62 of the above-described adjustment mechanism 60 are provided with respect to the support member 76. Additionally, the other end sides of the cylinders 61 and 62 are fixed to a structure 91 on the fluid supply unit 6 side. The structure 91 moves in the longitudinal direction D2 together with the moving base portion 56. With the above configuration, in a case where the cylinder 61 moves the support member 76 in the longitudinal direction D2, the slide unit 90 moves along the guide unit 89 via the support member 76. At this time, since the guide unit 89 has an arc shape, the support member 76 and the support member 77 also move so as to draw an arc-shaped trajectory in accordance with the arc shape of the guide unit 89. Accordingly, one end portion of the electrode unit 52 moves together with the support member 76 and the support member 77 so as to draw an arc-shaped trajectory. Accordingly, the electrode unit 52 as a whole rotates around a reference position (see FIGS. 9A and 9B). Here, the reference position is set at a center of curvature of the guide unit 89, and here, is set at a center position of the electrode unit 52. In addition, a method for connecting the cylinders 61 and 62 of the adjustment mechanism 60 to other members is not particularly limited, and the cylinders may be connected to other than connection points described above as long as the posture of the electrode 10 can be adjusted.

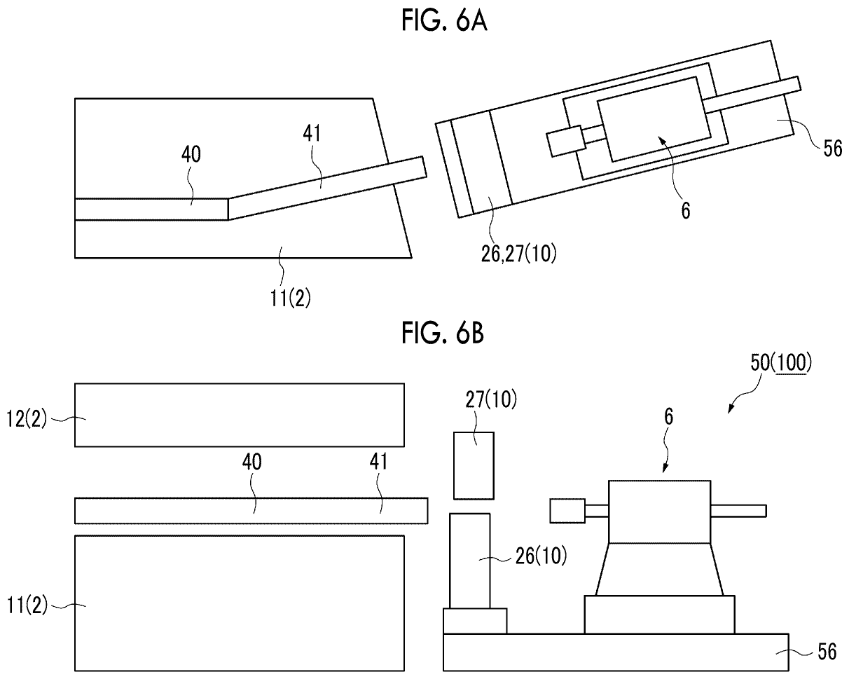

Next, an operation of the electric heating system 100 in a case where the forming device 1 forms the metal pipe material 40 will be described with reference to FIGS. 6A to 13B. FIGS. 6A to 13B are schematic views illustrating one heating and expanding unit 50 of the electric heating system 100. FIG. 6A is a schematic plan view, and FIG. 6B is a schematic side view. In addition, FIGS. 6A to 13B are described in a deformed state in order to emphasize features of the present disclosure. FIGS. 6A and 6B illustrate a basic posture of the heating and expanding unit 50.

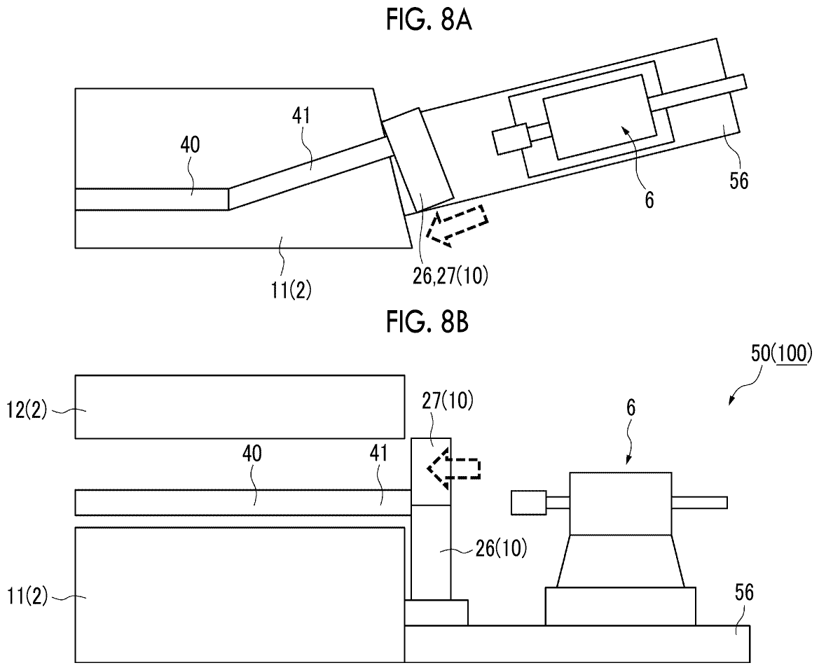

First, as illustrated in FIGS. 7A and 7B, the control unit 8 brings the electrodes 10 and the fluid supply units 6 closer to the forming tool 2 by moving the moving base portion 56. The control unit 8 adjusts the posture of the electrode 10 by the adjustment mechanism 60 (see FIG. 2) such that the electrode 10 and the straight portion 41 of the metal pipe material 40 before heating are perpendicular to each other. At this time, the control unit 8 disposes the lower electrodes 26 at positions that support the straight portions 41 and retreats the upper electrodes 27. Subsequently, as illustrated in FIGS. 8A and 8B, the control unit 8 moves the upper electrodes forward and holds the metal pipe material 40 by the electrodes 10.

Subsequently, as illustrated in FIGS. 9A and 9B, the control unit 8 electrically heats the metal pipe material 40 by the electrodes 10. At this time, the control unit 8 moves the electrode 10 so as to follow the deformation due to the influence of the thermal elongation of the metal pipe material 40 by controlling the adjustment mechanism 60 (see FIG. 2) and the actuator 88. Specifically, the electrode 10 moves so as to retreat according to the expansion in the longitudinal direction of the metal pipe material 40 and is adjusted in the posture by the adjustment mechanism 60 (see FIG. 2) while heating the metal pipe material 40 after holding the metal pipe material 40. At this time, the electrode 10 follows the spread of the metal pipe material 40 by rotating around the reference position CP. The control unit 8 adjusts a rotation speed of the electrode 10 or the like in accordance with the operation of the metal pipe material 40 based on the contents calculated in advance. The control unit 8 adjusts the posture of the electrode 10 such that the electrode 10 and the straight portion 41 are perpendicular to each other.

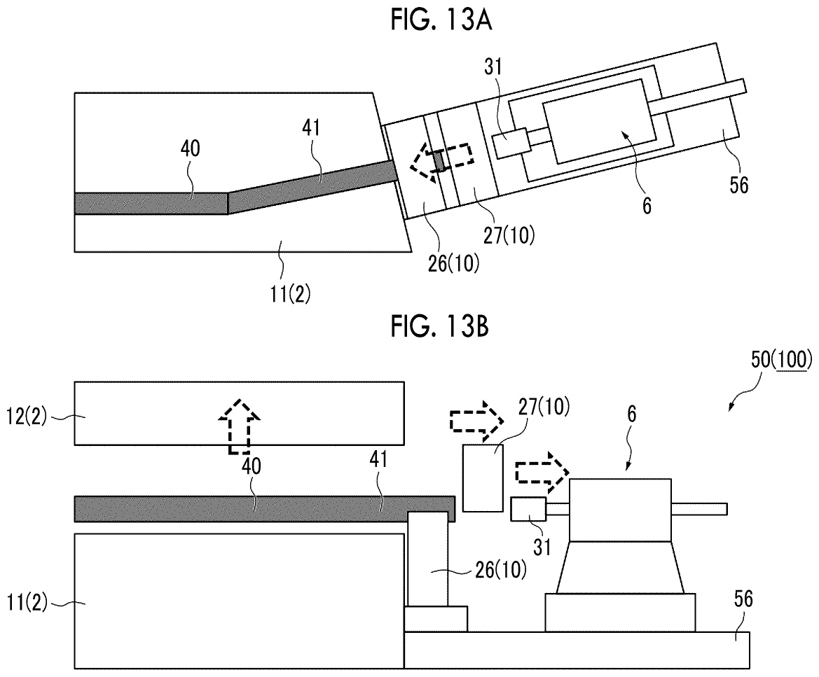

As illustrated in FIGS. 10A to 12B, after the movement and the adjustment in the posture, the electrode 10 releases the holding, and holds the metal pipe material 40 again. Specifically, as illustrated in FIGS. 10A and 10B, the control unit 8 releases the holding of the metal pipe material 40 by the electrode 10 by moving the upper electrode 27 upward. Subsequently, as illustrated in FIGS. 11A and 11B, the control unit 8 advances the electrode 10 so as to approach the forming tool 2. Subsequently, as illustrated in FIGS. 12A and 12B, the control unit 8 lowers the upper electrode 27 to hold the metal pipe material 40 again by the electrode 10. Additionally, the control unit 8 lowers the die 12. Additionally, the control unit 8 advances the nozzle 31 to insert the nozzle into the metal pipe material 40. Accordingly, after the electrode 10 holds the metal pipe material 40 again, the fluid supply unit 6 supplies the fluid to the metal pipe material 40. Accordingly, the forming is performed. As illustrated in FIGS. 13A and 13B, in a case where the forming is completed, the control unit 8 retreats the nozzle 31, raises the die, and retreats the upper electrode.

Subsequently, the operations and effects of the electric heating system 100 and the electrode 10 according to the present embodiment will be described.

The electric heating system 100 includes the adjustment mechanism 60 that rotates the electrode 10 around the predetermined reference position CP to adjust the posture. The electrode 10 heats the metal pipe material 40, and thus, the thermal elongation is generated in the metal pipe material 40. At this time, in a case where an angle of the metal pipe material 40 deviates from the electrode, the adjustment mechanism 60 can rotate the electrode 10 around the predetermined reference position CP to adjust the posture in accordance with the deviation. Accordingly, the adjustment mechanism 60 can reduce the deviation of the angle of the electrode 10 from the metal pipe material 40. From the above, it is possible to absorb the thermal elongation in a case where the bent metal pipe material 40 is heated. Accordingly, the forming accuracy can be improved.

The electric heating system 100 includes the adjustment mechanism 60 that adjusts the posture of the electrode 10 in accordance with the fact that the metal pipe material 40 is deformed in a case where the metal pipe material 40 is heated by the electrode 10. The electrode 10 heats the metal pipe material 40, and thus, the thermal elongation is generated in the metal pipe material 40. At this time, in a case where the position of the metal pipe material 40 deviates from the electrode 10, the adjustment mechanism 60 can adjust the posture of the electrode 10 in accordance with the fact that the metal pipe material 40 is deformed according to the deviation. Accordingly, the adjustment mechanism 60 can reduce the deviation of the position of the electrode 10 from the metal pipe material 40. From the above, it is possible to absorb the thermal elongation in a case where the bent metal pipe material 40 is heated.

The adjustment mechanism 60 includes at least the pair of cylinders 61 and 62 provided for the electrode 10. In this case, the adjustment mechanism 60 can accurately adjust the posture of the electrode 10 by using the pair of cylinders 61 and 62.

The electrode 10 moves according to the expansion in the longitudinal direction of the metal pipe material 40 and is adjusted in the posture by the adjustment mechanism 60 while heating the metal pipe material 40 after holding the metal pipe material 40, and releases the holding and holds the metal pipe material 40 again after the movement and the adjustment in the posture. In this case, in a case where the reaction force due to the thermal expansion is generated between the electrode 10 and the metal pipe material 40 by releasing the holding of the electrode 10 after the movement and the adjustment in the posture, the reaction force can be released. Then, in a state in which the reaction force is released, the electrode 10 can hold the metal pipe material 40 again in an appropriate posture corresponding to the thermal elongation. Additionally, in this manner, since the deviation of the angle between the electrode 10 and the metal pipe material 40 after heating can be reduced, it is possible to suppress the deformation of the metal pipe material 40 in a case where the holding after heating is released and the metal pipe material is held again.

The electric heating system 100 further includes the fluid supply unit 6 that supplies the fluid to the metal pipe material 40, and after the electrode 10 holds the metal pipe material 40 again, the fluid supply unit 6 supplies the fluid to the metal pipe material 40. Even in a case where a gap is formed between the forming tool 2 and the metal pipe material 40 due to the influence of the reaction force due to the thermal expansion, after the electrode 10 releases the holding, the electrode holds the metal pipe material again, and thus, the gap between the forming tool 2 and the metal pipe material 40 can be reduced. The fluid supply unit 6 can form the high-quality molding product by supplying the fluid to the metal pipe material 40 in this state.

The electrode 10 according to the present embodiment is the electrode that holds the bent metal pipe material 40, and energizes and heats the metal pipe material 40, and is adjusted in the posture by rotating around the predetermined reference position CP.

In accordance with the electrode 10 according to the present embodiment, it is possible to obtain the operations and effects having the same meaning as that of the above-described electric heating system 100.

From the above, in the electric heating system 100 and the electrode 10, even in a case where there is a variation in preliminary bending accuracy (bending angle) of the bent metal pipe material 40, since the angle can be corrected by adjusting the posture of the electrode 10, the variation can be allowed.

In accordance with the forming system according to the present embodiment, the adjustment mechanism adjusts the posture of the holding mechanism (here, the electrode 10) in accordance with the fact that the heated metal pipe material 40 (metal material) is deformed. Accordingly, even in a case where the position of the metal pipe material 40 deviates from the holding mechanism, the holding mechanism can hold the metal pipe material 40 in an appropriate posture.

The metal pipe material 40 may be heated inside the forming device 1.

The adjustment mechanism may adjust the posture of the holding mechanism in accordance with the fact that the metal pipe material 40 is heated inside the forming device 1 and is deformed during heating. In this case, it is possible to perform forming corresponding to the deformation of the metal pipe material 40 caused during heating inside the forming device 1.

The present disclosure is not limited to the above-described embodiment.

Although it has been described that the metal pipe material is used as the metal material, the present disclosure may also be applied in a case where a bent plate material is energized and heated.

A specific configuration of the adjustment mechanism may be appropriately changed as long as the posture of the electrode can be adjusted.

In the above-described embodiment, although the fluid supply unit is the mechanism that does not move in the width direction, as the mechanism movable in the width direction, the fluid supply unit may be able to follow the deformation of the thermal elongation. Additionally, since the electrode and the fluid supply unit may be movable in the width direction and the vertical direction, the forming may cope with three-dimensional deformation of the metal material.

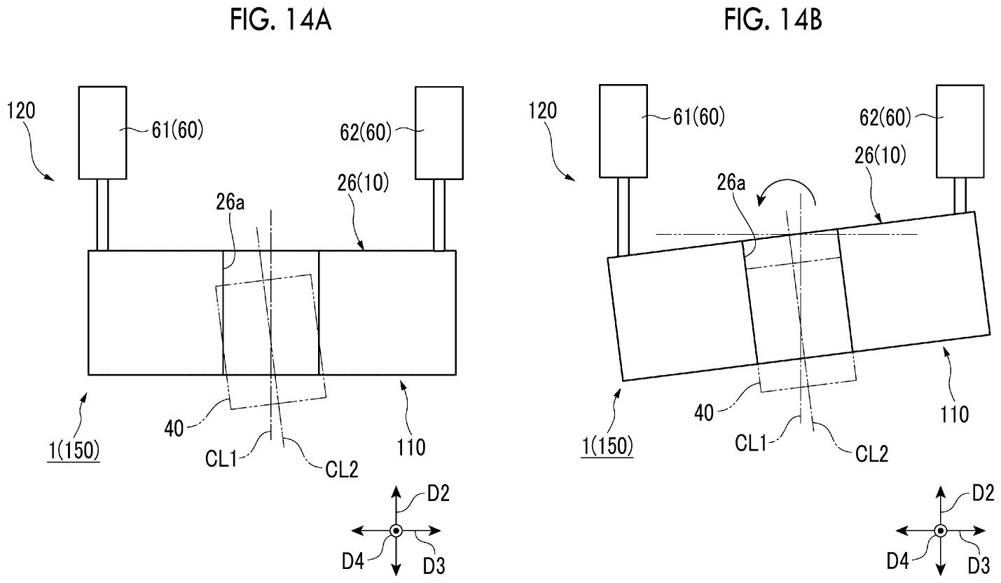

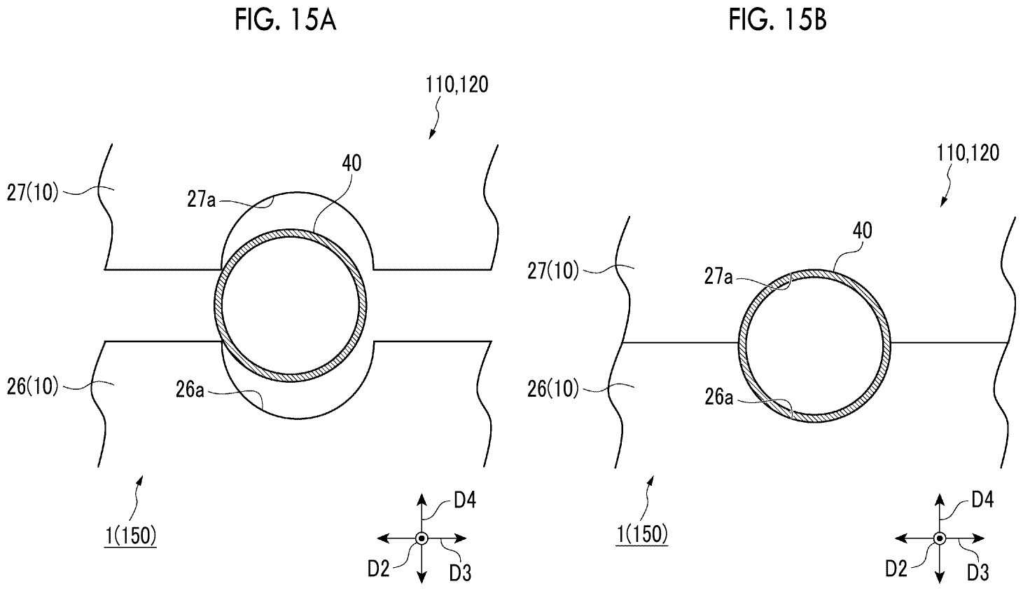

As illustrated in FIGS. 14A to 15B, the forming device 1 is a forming device 1 that performs expansion forming of the heated metal pipe material 40. The forming device 1 includes a holding mechanism 110 and an adjustment mechanism 120. In addition, in FIGS. 14A to 15B, a vertical direction D4 is illustrated in addition to the longitudinal direction D2 and the width direction D3. The holding mechanism 110 holds the metal pipe material 40. The adjustment mechanism 120 adjusts a relative posture of the holding mechanism 110 with respect to the metal pipe material 40 in accordance with the positional deviation of the metal pipe material 40 during holding. The adjustment mechanism 120 adjusts the posture of the holding mechanism 110 with respect to the metal pipe material 40. The forming device 1 has a configuration having the same meaning as that of the forming device 1 illustrated in FIG. 1. The forming device 1 includes a support device 150 that supports the metal pipe material 40.

The holding mechanism 110 according to the present embodiment includes the electrode 10 and a mechanism for opening and closing the electrode 10. The adjustment mechanism 120 has mechanisms for rotating and sliding the electrode 10 such as the cylinders 61 and 62. The electrodes 26 and 27 of the holding mechanism 110 hold the metal pipe material 40 by sandwiching the metal pipe material 40 between the groove portions 26a and 27a. Here, in a case where the metal pipe material 40 is deformed from an assumed shape, the position of the metal pipe material 40 during holding deviates from the holding mechanism 110. As illustrated in FIG. 15A, immediately before the holding mechanism 110 holds the metal pipe material 40, the metal pipe material 40 is disposed between the groove portions 26a and 27a in a state in which the electrodes 26 and 27 are open.

At this time, as illustrated in FIG. 14A, as viewed in the vertical direction, the positional deviation is caused such that a center line CL2 of the metal pipe material 40 is inclined with respect to a center line CL1 of the groove portion 26a. Such positional deviation caused due to an error during manufacturing of the metal pipe material 40, a thermal deformation error due to heating, or the like. For example, in a case where the forming device 1 includes an external heating unit that heats the metal pipe material 40 outside the forming tool 2, after the metal pipe material 40 is heated by the external heating unit, in a case where the heated metal pipe material 40 is moved to the holding mechanism 110 by a robot hand or the like, the thermal deformation error may be generated by thermal contraction due to cooling or the like. In this case, the adjustment mechanism 120 adjusts the posture in accordance with the fact that the metal pipe material 40 is deformed in a case where the metal pipe material is heated in a preliminary stage of being held by the holding mechanism 110 and moves to the holding mechanism 110. In this manner, the adjustment mechanism 120 may adjust the posture of at least one of the holding mechanism 110 or the metal material in accordance with the fact that the metal material is heated outside the forming device 1 and is deformed during transportation to the forming device 1. In this case, it is possible to perform forming corresponding to the deformation of the metal material caused during the transportation to the forming device 1.

Here, the adjustment mechanism 120 is set such that the electrode 10 is in a free state (a state in which the resistance during rotation is as small as possible) by adjusting a pressure valve such that cylinder pressures of the cylinders 61 and 62 are released. The electrodes 26 and 27 illustrated in FIG. 15B are closed, and thus, the metal pipe material 40 is held by the groove portions 26a and 27a. At this time, as illustrated in FIG. 14B, while the groove portion 26a (27a) rotates by an error according to an inclination angle of the metal pipe material 40, the metal pipe material 40 is clamped while entering the groove portion 26a (27a). In this manner, the adjustment mechanism 120 adjusts the posture of the holding mechanism 110 by rotating holding mechanism so as to be in a posture that matches the positional deviation of the metal pipe material 40.

In accordance with the forming device 1 (forming system) according to the present embodiment, the adjustment mechanism 120 adjusts the relative posture of the holding mechanism 110 with respect to the metal pipe material 40 in accordance with the positional deviation of the metal pipe material 40 during holding. Accordingly, even in a case where the position of the metal pipe material 40 deviates from the holding mechanism 110, the holding mechanism 110 can hold the metal pipe material 40 in an appropriate posture.

The adjustment mechanism 120 may adjust the posture of the holding mechanism 110 with respect to the metal pipe material 40. In this case, since the holding mechanism 110 is adjusted in the posture in accordance with the positional deviation of the metal pipe material 40, it is possible to suppress the crushing of the metal pipe material 40 or the like.

The adjustment mechanism 120 may adjust the posture in accordance with the fact that the metal pipe material 40 is heated in a preliminary stage of being held by the holding mechanism 110 and is deformed in a case where the metal pipe material 40 moves to the holding mechanism 110. In this case, even though the heated metal pipe material 40 is deformed during moving, the holding mechanism 110 can hold the metal pipe material 40 in an appropriate posture.

In accordance with the support device 150 according to the present embodiment, it is possible to obtain the operations and effects having the same meaning as that of the above-described forming device 1.

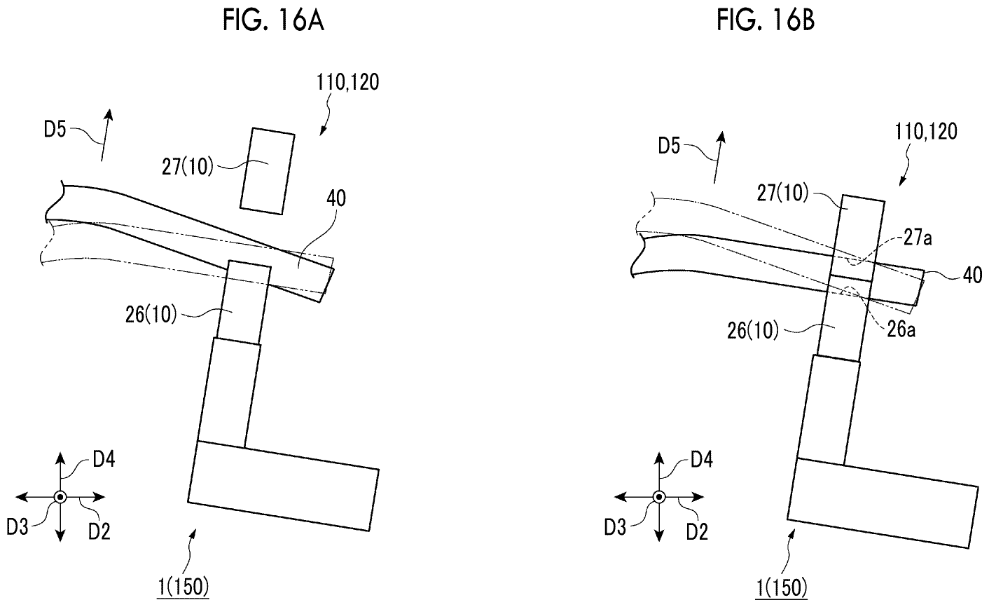

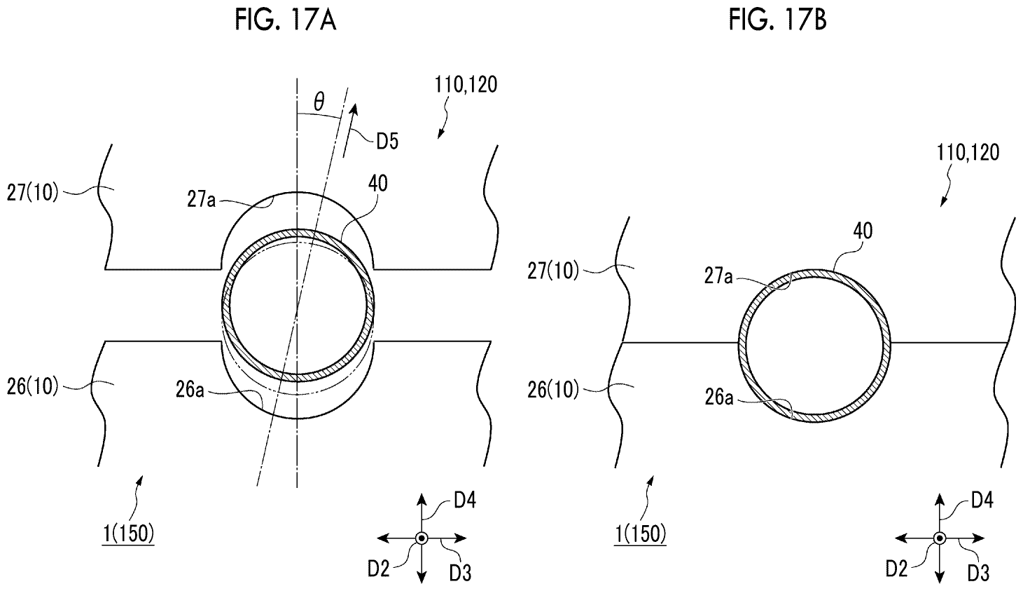

Next, a forming device 1 and a support device 150 according to another embodiment will be described with reference to FIGS. 16A to 17B. As illustrated in FIGS. 16A to 17B, a holding mechanism 110 has electrodes 26 and 27 that are divided in a vertical direction. An adjustment mechanism 120 in the present embodiment includes a mechanism for driving the electrodes 26 and 27. The adjustment mechanism 120 deforms a metal pipe material 40 in accordance with a holding aspect of the holding mechanism 110.

As illustrated in FIG. 17A, the holding mechanism 110 holds the metal pipe material 40 such that a bending direction D5 of the metal pipe material 40 as viewed from a longitudinal direction D2 is substantially the same as a clamping direction (vertical direction D4) by the electrodes 26 and 27. In addition, the bending direction D5 as viewed from the longitudinal direction D2 does not have to completely coincide with the clamping direction (vertical direction D4), and may be inclined in a range where the inclination angle θ is equal to or less than 1°.

Here, in a case where the metal pipe material 40 is deformed from an assumed shape, the position of the metal pipe material 40 during holding deviates from the holding mechanism 110. For example, as illustrated in FIG. 16A, the assumed shape of the metal pipe material 40 is a shape indicated by an imaginary line, whereas the metal pipe material 40 to be held is greatly bent in the bending direction D5. At this time, as viewed from a width direction D3, the position of the metal pipe material 40 deviates so as to be inclined with respect to the electrodes 26 and 27. However, since the bending direction D5 and the clamping direction (vertical direction D4) are substantially the same, as illustrated in FIG. 17B, in a state viewed from the longitudinal direction D2, even though the metal pipe material 40 is deformed from the assumed shape (shape indicated by the imaginary line), the metal pipe material 40 is disposed at a position where the metal pipe material can be clamped by the groove portions 26a and 27a.

The electrodes 26 and 27 illustrated in FIG. 17B are closed, and thus, the metal pipe material 40 is held by the groove portions 26a and 27a. At this time, as illustrated in FIG. 16B, the adjustment mechanism 120 deforms the metal pipe material 40 in accordance with the holding aspect of the holding mechanism 110. Specifically, the adjustment mechanism 120 clamps the metal pipe material 40 while applying a pressure such that the metal pipe material 40 is deformed by the electrodes 26 and 27. Accordingly, the shape of the metal pipe material 40 (shape indicated by the imaginary line) in which the positional deviation has been caused is deformed to be a shape (shape indicated by a solid line) that matches the shapes of the groove portions 26a and 27a of the electrodes 26 and 27.

As described above, the adjustment mechanism 120 may deform the metal pipe material 40 in accordance with the holding aspect of the holding mechanism 110. In this case, the metal pipe material 40 is deformed so as to have a shape that matches the holding mechanism 110, and thus, the holding mechanism 110 can hold the metal pipe material 40 in an appropriate posture.

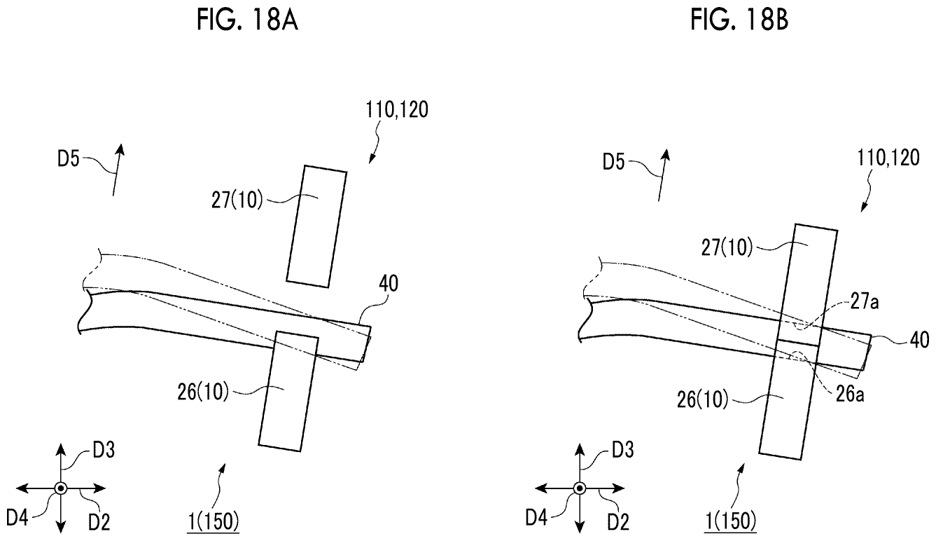

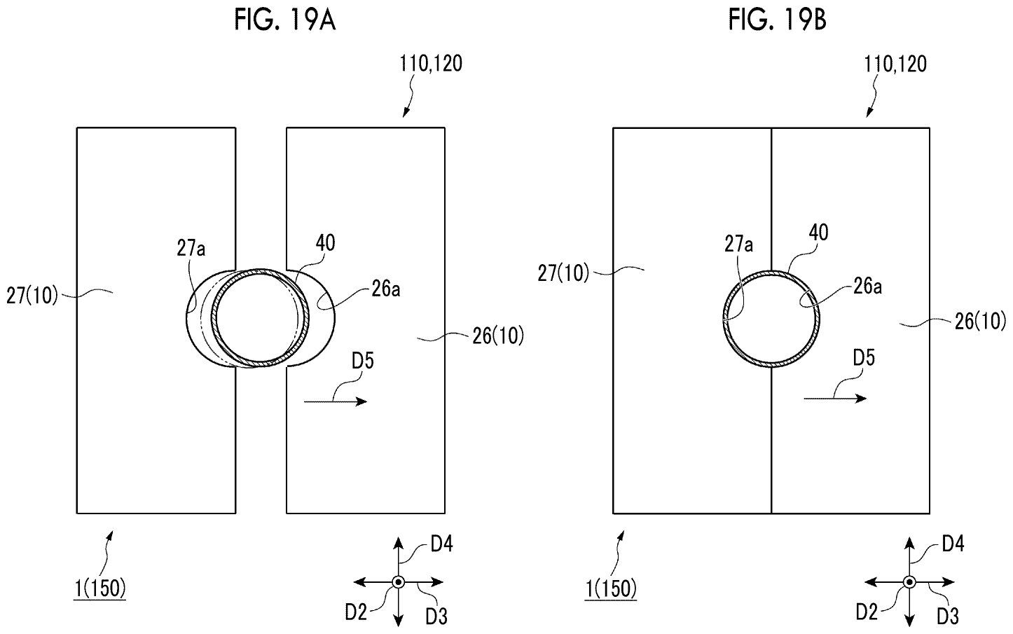

In addition, as illustrated in FIGS. 18A and 18B, the bending direction D5 of the metal pipe material 40 as viewed from the longitudinal direction D2 may be substantially the same as the width direction D3. In this case, as illustrated in FIGS. 18A to 19B, the holding mechanism 110 may have the electrodes 26 and 27 such that the clamping direction is the width direction D3. In this case, the bending direction D5 of the metal pipe material 40 as viewed from the longitudinal direction D2 is substantially the same as the clamping direction (width direction D3) of the electrodes 26 and 27. Thus, the operations and effects having the same meaning as that of the forming device 1 described with reference to FIGS. 16A to 17B can be obtained.

In addition, in the forming device 1 illustrated in FIGS. 14A to 19B, the support device 150 is provided at a position adjacent to the forming tool 2 (see FIG. 1). Alternatively, the support device 150 may be provided at a position spaced apart from the forming tool 2 to support the metal pipe material 40 outside the forming tool 2. At this time, a clamp member of the holding mechanism 110 may be an electrode capable of energizing and heating, or may be a member not having an energizing and heating function. In this manner, the holding mechanism 110 may or may not have the energization heating function.

[Form 1]

Provided is a forming system having a forming device that forms a heated metal material.

The forming system includes a holding mechanism that holds the metal material, and an adjustment mechanism that adjusts a posture of at least one of the holding mechanism or the metal material in accordance with a fact that the heated metal material is deformed.

[Form 2]

In the forming system according to Form 1, the metal material is heated outside the forming device.

[Form 3]

In the forming system according to Form 2, the adjustment mechanism adjusts the posture of at least one of the holding mechanism or the metal material in accordance with a fact that the metal material is heated outside the forming device and is deformed during transportation to the forming device.

[Form 4]

In the forming system according to Form 1, the metal material is heated inside the forming device.

[Form 5]

In the forming system according to Form 4, the adjustment mechanism adjusts the posture of at least one of the holding mechanism or the metal material in accordance with a fact that the metal material is heated inside the forming device and is deformed during heating.

[Form 6]

Provided is an electric heating system of a metal material. The system includes an electrode that holds a bent metal material and energizes and heats the metal material, and an adjustment mechanism that rotates the electrode around a predetermined reference position to adjust a posture.

[Form 7]

Provided is an electric heating system of a metal material. The system includes an electrode that holds a bent metal material, and energizes and heats the metal material, and an adjustment mechanism that adjusts a posture of the electrode in accordance with a fact that the metal material is deformed in a case where the metal material is heated by the electrode.

[Form 8]

In the electric heating system according to Form 6 or 7, the adjustment mechanism includes at least a pair of cylinders provided for the electrode.

[Form 9]

In the electric heating system according to any one of Form 6 to Form 8, the electrode moves according to expansion in a longitudinal direction of the metal material and is adjusted in the posture by the adjustment mechanism while heating the metal material after holding the metal material, and releases the holding and holds the metal material again after the movement and the adjustment in the posture.

[Form 10]

The electric heating system according to Form 9, further includes a fluid supply unit that supplies a fluid to a metal pipe material as the metal material, and after the electrode holds the metal pipe material again, the fluid supply unit supplies the fluid to the metal pipe material.

[Form 11]

Provided is an electrode that holds a bent metal material and energizes and heats the metal material. The electrode is adjusted in a posture by rotating around a predetermined reference position.

[Form 12]

Provided is a forming device that performs expansion forming of a heated metal pipe material.

The forming device includes a holding mechanism that holds the metal pipe material, and an adjustment mechanism that adjusts a relative posture of the holding mechanism with respect to the metal pipe material in accordance with positional deviation of the metal pipe material during the holding.

[Form 13]

In the forming device according to Form 12, the adjustment mechanism adjusts the posture of the holding mechanism with respect to the metal pipe material.

[Form 14]

In the forming device according to Form 12, the adjustment mechanism deforms the metal pipe material according to a holding aspect of the holding mechanism.

[Form 15]

In the forming device according to any one of Forms 12 to 14, the adjustment mechanism adjusts the posture in accordance with a fact that the metal pipe material is heated in a preliminary stage of being held by the holding mechanism and is deformed in a case where the metal pipe material moves to the holding mechanism.

[Form 16]

Provided is a support device including a holding mechanism that holds a heated metal pipe material to perform expansion forming of the metal pipe material, and an adjustment mechanism that adjusts a relative posture of the holding mechanism with respect to the metal pipe material in accordance with positional deviation of the metal pipe material during the holding.

It should be understood that the invention is not limited to the above-described embodiment, but may be modified into various forms on the basis of the spirit of the invention. Additionally, the modifications are included in the scope of the invention.

What is claimed is:

1. A forming system including a forming device that forms a heated metal material, comprising:
a holding mechanism that holds the metal material; and
an adjustment mechanism that adjusts a posture of at least one of the holding mechanism or the metal material in accordance with a fact that the heated metal material is deformed.

2. The forming system according to claim 1, wherein the metal material is heated outside the forming device.

3. The forming system according to claim 2, wherein the adjustment mechanism adjusts the posture of at least one of the holding mechanism or the metal material in accordance with a fact that the metal material is heated outside the forming device and is deformed during transportation to the forming device.

4. The forming system according to claim 1, wherein the metal material is heated inside the forming device.

5. The forming system according to claim 4, wherein the adjustment mechanism adjusts the posture of at least one of the holding mechanism or the metal material in accordance with a fact that the metal material is heated inside the forming device and is deformed during heating.

6. The forming system according to claim 1, wherein the adjustment mechanism includes a first cylinder that generates a driving force for rotating the holding mechanism, and a second cylinder for following a movement of the holding mechanism accompanying thermal elongation of the metal material.

7. The forming system according to claim 6, wherein the second cylinder supports the holding mechanism on a side opposite to the first cylinder.

8. The forming system according to claim 1, further comprising:
a forming tool that includes a lower die and an upper die that face each other in a vertical direction; and
a drive mechanism that moves at least one of the lower die and the upper die.

9. The forming system according to claim 8, wherein the drive mechanism lowers the upper die and brings the upper die close to the lower die to close the forming tool.

10. An electric heating system of a metal material, comprising:
an electrode that holds a bent metal material and energizes and heats the metal material; and
an adjustment mechanism that rotates the electrode around a predetermined reference position to adjust a posture.

11. An electric heating system of a metal material, comprising:
an electrode that holds a bent metal material, and energizes and heats the metal material; and
an adjustment mechanism that adjusts a posture of the electrode in accordance with a fact that the metal material is deformed in a case where the metal material is heated by the electrode.

12. The electric heating system according to claim 10, wherein the adjustment mechanism includes at least a pair of cylinders provided for the electrode.

13. The electric heating system according to claim 10, wherein the electrode moves according to expansion in a longitudinal direction of the metal material and is adjusted in the posture by the adjustment mechanism while heating the metal material after holding the metal material, and releases the holding and holds the metal material again after the movement and the adjustment in the posture.

14. The electric heating system according to claim 13, further comprising;
a fluid supply unit that supplies a fluid to a metal pipe material as the metal material,
wherein, after the electrode holds the metal pipe material again, the fluid supply unit supplies the fluid to the metal pipe material.

15. An electrode that holds a bent metal material and energizes and heats the metal material,
wherein the electrode is adjusted in a posture by rotating around a predetermined reference position.

16. A forming device that performs expansion forming of a heated metal pipe material, the device comprising:
a holding mechanism that holds the metal pipe material; and
an adjustment mechanism that adjusts a relative posture of the holding mechanism with respect to the metal pipe material in accordance with positional deviation of the metal pipe material during the holding.

17. The forming device according to claim 16, wherein the adjustment mechanism adjusts the posture of the holding mechanism with respect to the metal pipe material.

18. The forming device according to claim 16, wherein the adjustment mechanism deforms the metal pipe material according to a holding aspect of the holding mechanism.

19. The forming device according to claim 16, wherein the adjustment mechanism adjusts the posture in accordance with a fact that the metal pipe material is heated in a preliminary stage of being held by the holding mechanism and is deformed in a case where the metal pipe material moves to the holding mechanism.

20. A support device comprising:
a holding mechanism that holds a heated metal pipe material to perform expansion forming of the metal pipe material; and
an adjustment mechanism that adjusts a relative posture of the holding mechanism with respect to the metal pipe material in accordance with positional deviation of the metal pipe material during the holding.
